(19) United States
(12) Patent Application Publication
(10) Pub. No.: US 2026/0085711 A1
(43) Pub. Date: Mar. 26, 2026

(54) CHAIR

(71) Applicant: WONDERLAND SWITZERLAND AG, Steinhausen (CH)

(72) Inventors: Zhengwen GUO, Dongguan (CN); Wenqu HU, Dongguan (CN)

(21) Appl. No.: 19/333,766

(22) Filed: Sep. 19, 2025

(30) Foreign Application Priority Data
Sep. 20, 2024 (CN) 202411319721.9

(51) Int. Cl. F16B 12/48; A47D 1/00

(52) U.S. Cl. CPC F16B 12/48; A47D 1/006; A47D 1/008

(57) ABSTRACT

The present disclosure provides a chair, including a chair body and support legs connectable to the chair body. One of a lower part of the chair body and an upper part of the support legs is provided with a mounting part, and the other of the lower part of the chair body and the upper part of the support legs is provided with an insertion part. The insertion part is insertable into the mounting part along an insertion direction to mount the support legs to the chair body. A tight-fitting rib protruding inwardly is provided on an inner surface of a circumferential sidewall of the mounting part, and when the insertion part is inserted into the mounting part, the tight-fitting rib undergoes elastic deformation to abut between the insertion part and the circumferential sidewall of the mounting part, thereby securely mounting the support legs to the chair body.

### CROSS-REFERENCE TO RELATED APPLICATION

This application claims priority to Chinese Application No. 202411319721.9 filed on Sep. 20, 2024, which is incorporated herein by reference in its entirety.

### TECHNICAL FIELD

The present disclosure provides a chair connection structure and a chair including the chair connection structure.

### BACKGROUND

Children's indoor products provide convenience for children's indoor activities, and generally include children's dining chairs, chair stands, rocking chairs, carry cots, etc. Children's dining chairs usually include a chair body and support legs under the chair body. In some usage environments, the chair may be made of specific materials, such as wood, in order to be consistent with a style of a furniture. One problem at present is that the support legs such as those made of woods require a manual polishing process, there are large manufacturing tolerances. As a result, there is a gap between such support legs and the chair body, making the chair shaking and unstable and reducing the user experience.

Therefore, it is necessary to design a novel chair connection structure, which can ensure the stable connection between the support legs and the chair body when there is a manufacturing tolerance between the support legs and the chair body.

### SUMMARY

A chair according to the present disclosure includes a chair body and support legs connectable to the chair body, one of a lower part of the chair body and an upper part of the support legs being provided with a mounting part, and the other of the lower part of the chair body and the upper part of the support legs being provided with an insertion part, the insertion part being insertable into the mounting part along an insertion direction to mount the support legs to the chair body. A tight-fitting rib protruding inwardly is provided on an inner surface of a circumferential sidewall of the mounting part, and when the insertion part is inserted into the mounting part, the tight-fitting rib is elastically deformed to abut between the insertion part and the circumferential sidewall of the mounting part, securely mounting the support legs to the chair body.

In one embodiment, the circumferential sidewall has a symmetry plane, and the tight-fitting rib is provided in a plurality, the plurality of tight-fitting ribs are symmetrically distributed with respect to the symmetry plane.

In one embodiment, the tight-fitting rib extends over an entire depth of the circumferential sidewall.

In one embodiment, the tight-fitting rib has a thickness of 0.9-1.5 mm along the circumferential sidewall.

In one embodiment, the circumferential sidewall of the mounting part is provided with a plurality of tight-fitting ribs, and a sum of heights of the tight-fitting ribs disposed opposite to each other of the plurality of tight-fitting ribs is 0.5-0.9 mm.

In one embodiment, the insertion part is provided with a positioning part, and the circumferential sidewall of the mounting part is provided with an anti-mismatching rib corresponding to the positioning part.

In one embodiment, the mounting part further includes a bottom wall, the bottom wall is provided with one or more abutment parts, a top face of the abutment part forms an abutment plane, the abutment plane is parallel to an upper surface of the support leg, and when the insertion part is inserted into the mounting part, the abutment plane abuts against the upper surface of the support leg.

In one embodiment, the chair further includes a connector, a receiving part is formed on a side surface of the insertion part, the connector is mounted in the receiving part, the connector further includes a connector body and a locking part extending from the connector body, the circumferential sidewall of the mounting part is further provided with a locking hole, and when the insertion part is inserted into the mounting part, the locking part is locked in the locking hole.

In one embodiment, the connector body has a peripheral surface, the connector body includes a plurality of engaging parts protruding from the peripheral surface and distributed at intervals along the peripheral surface.

In one embodiment, the connector body further includes an engaging protrusion provided on one or more of the engaging parts, and the engaging protrusion protrudes from the engaging part.

### BRIEF DESCRIPTION OF THE DRAWINGS

FIG. 1 is an exemplary chair according to the present disclosure;

FIG. 2 is a bottom view of a chair body of the chair;

FIG. 3 is a partial enlarged view of a portion as indicated by a block of FIG. 2;

FIG. 4A is a further enlarged view of a tight-fitting rib of FIG. 3;

FIG. 4B is a partially enlarged perspective view of the tight-fitting rib at another angle;

FIG. 5 is a partial enlarged cross-sectional view taken along a line AA of FIG. 1;

FIG. 6 and FIG. 7 are perspective views of the support legs of the chair at different angles;

FIG. 8 is a perspective view of the support leg of FIG. 7 with the connector removed from different angles;

FIG. 9 and FIG. 10 are perspective views of a connecting member at different angles;

FIG. 11 is a front cross-sectional view of the chair;

FIG. 12 is a partial enlarged view of a portion as indicated by a block of FIG. 11.

### REFERENCE NUMERALS LIST

1 Chair
100 Mounting Part
110 Circumferential Sidewall
111 Left Sidewall
112 Right Sidewall
113 Upper Sidewall
114 Lower Sidewall
120 Mounting Groove
130 Tight-Fitting Rib
131 Top Face
131a Rounded Portion
132 End Face
W1 First Width
W2 Second Width
133 Side Face
140 Abutment Part
150 Anti-Mismatching Rib
160 Locking Hole
170 Bottom Wall
W Thickness Direction
H Height Direction
D Depth Direction
S Symmetry Plane
200 Insertion Part
210 Positioning Part
220 Receiving Part
300 Connector
310 Outer Surface
311 Locking Protrusion
312 Gap
320 Periphery Surface
321 Engaging Part
322 Engaging Protrusion
400 Chair Body
500 Support Legs
501 Upper Surface
502 Lower Surface

### DETAILED DESCRIPTION

Although the present disclosure is illustrated and described with reference to specific embodiments, the present disclosure should not be limited to the details shown. Specifically, various modifications may be made to these details within the scope of equivalents of the claims and without departing from the present disclosure.

The directional descriptions such as “front”, “rear”, “upper” and “lower” mentioned in this text are used merely for the convenience of understanding. The present disclosure is not limited to these directions and may be adjusted according to the actual situation.

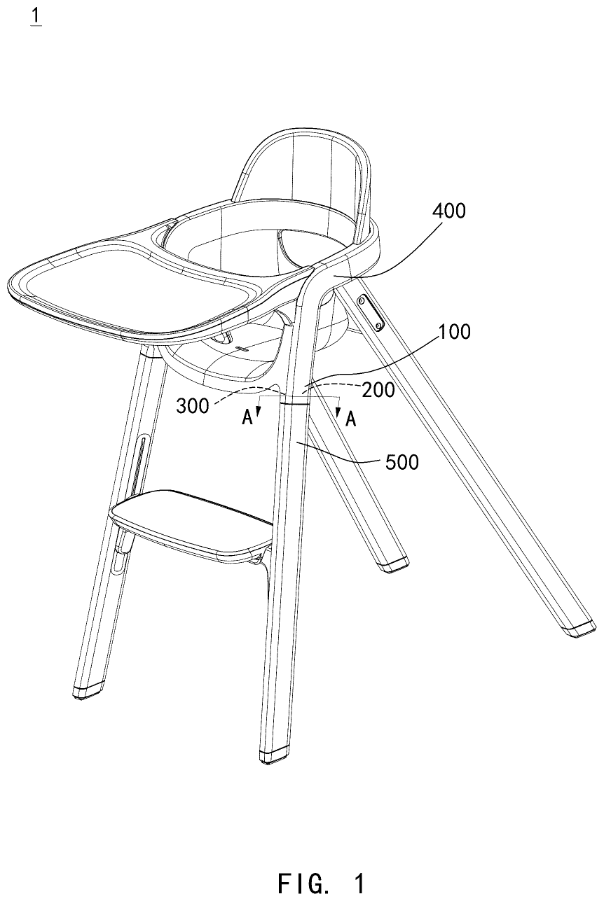

Referring to FIG. 1, the chair 1 according to the present disclosure is described. The chair 1, for example, is a child's dining chair, which includes a chair body 400 and support legs 500 that may be detachably connected to the chair body 400. The chair body 400 is adapted to support a child, and the support legs 500 are connected to a lower part of the chair body 400 to support the chair body 400 on a support plane (e.g., the floor). The lower part of the chair body 400 is provided with a mounting part 100, and an upper part of the support legs 500 is provided with an insertion part 200. The support legs 500 may be connected to the chair body 400 by inserting (i.e., inserting and connecting) the insertion part 200 into the mounting part 100. It should be understood that the mounting part 100 may also be provided on the chair body 400, and the insertion part 200 may be provided on the support legs 500, and the support legs 500 may be connected to the chair body 400 by inserting the insertion part 200 into the mounting part 100.

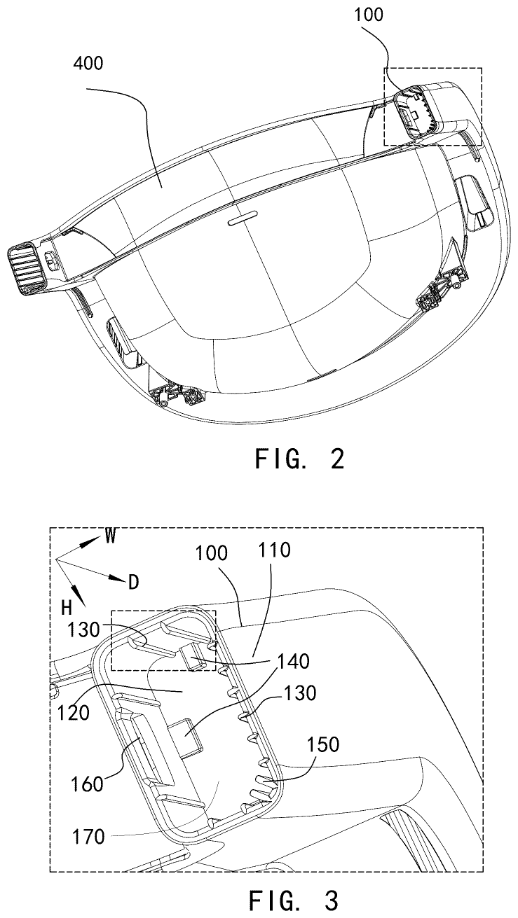

Referring to FIG. 2 and FIG. 3, the mounting part 100 according to the present disclosure is described in more detail. In this embodiment, the mounting part 100 is tubular and opened at an end, thereby forming a mounting groove 120. The mounting part 100 has a circumferential sidewall 110, for example, a substantially rectangular circumferential sidewall 110. In use, the insertion part 200 is inserted into the mounting part 100 along the circumferential sidewall 110 through an open end of the mounting part 100. Due to manufacturing tolerances, it is possible that there are some gaps between the insertion part 200 and the circumferential sidewall 110 of the mounting part 100, which may cause shaking or instability of the support legs 500. An inner side of the circumferential sidewall 110 is provided with at least one tight-fitting rib 130 protruding towards a center of the mounting part 100. Moreover, when the insertion part 200 is inserted into the mounting part 100, the insertion part 200 abuts against the tight-fitting rib 130, causing the tight-fitting rib 130 to undergo elastic deformation, thereby causing the tight-fitting rib 130 to abut between the insertion part 200 and the circumferential sidewall of the mounting part 100. In some embodiments, more specifically, when the insertion part 200 is inserted into the mounting part 100, the tight-fitting rib 130 undergoes lateral deflection and abuts between the insertion part 200 and the mounting part 100. In this way, the tight-fitting rib 130 tightly abuts against the insertion part 200, so that the insertion part 200 (and the support legs 500) is stably held in the mounting part 100. Here, the “lateral” refers to a thickness direction W of the tight-fitting rib 130. It should be understood that, for the case where a plurality of tight-fitting ribs 130 are provided on the circumferential sidewall 110, each tight-fitting rib 130 may extend in a different direction, that is, height directions H of the tight-fitting ribs 130 may be different from each other, and the thickness directions W of the tight-fitting ribs 130 may also be different from each other. Preferably, the tight-fitting rib 130 is elastic, so that after the insertion part 200 is disengaged from the mounting part 100, the tight-fitting rib 130 returns to its initial upright state under its own elasticity (as shown in FIG. 3).

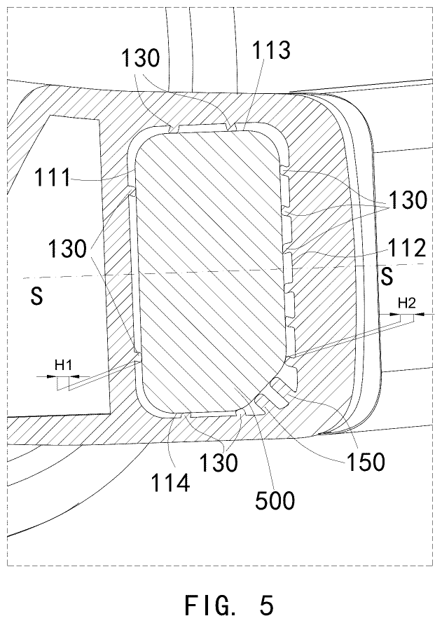

In some embodiments, a plurality of tight-fitting ribs 130 are provided on the circumferential sidewall 110 and are symmetrically distributed along the circumferential sidewall 110, for example, symmetrically distributed along the symmetry plane S of the mounting part 100, as shown in FIG. 5. In some embodiments, the circumferential sidewall 110 is substantially rectangular and includes left and right sidewalls that are longer and upper and lower sidewalls that are shorter. The number of the tight-fitting ribs provided on the upper and lower sidewalls is less than the number of the tight-fitting ribs provided on the left and right sidewalls. For example, six tight-fitting ribs 130 may be provided on the right sidewall, and two tight-fitting ribs 130 may be provided on the upper sidewall, but the present disclosure is not limited thereto, and the tight-fitting ribs provided on each sidewall may be in other numbers. Due to the symmetrically distributed tight-fitting ribs 130, the insertion part 200 may be more stably held. In some embodiments, the tight-fitting rib 130 extends over the entire circumferential sidewall 110 in a depth direction D, that is, from the open end of the mounting part 100 to a closed bottom wall 170 of the mounting part 100. In this way, the tight-fitting rib 130 can play a role of tightly fitting the insertion part 200 to the mounting part during the entire process of the insertion part 200 being inserted into the mounting part 100 along the depth direction D.

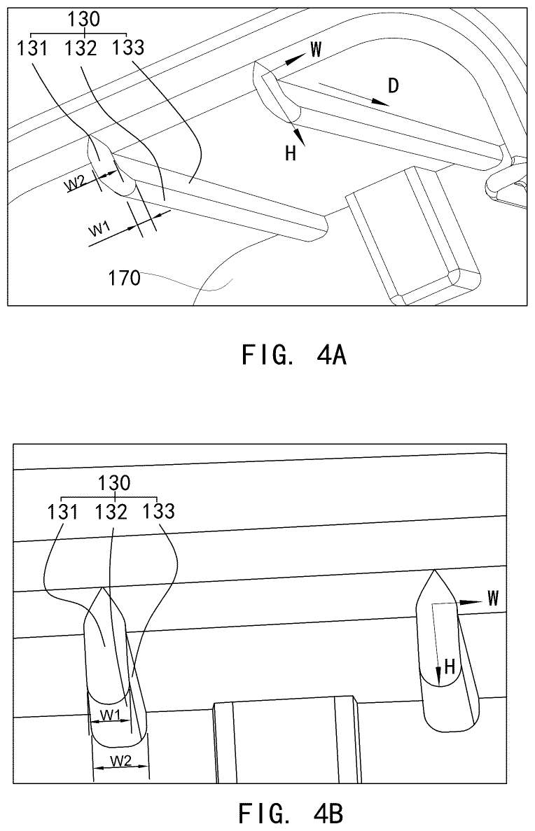

The structure of the tight-fitting rib 130 is described in more detail with reference to FIG. 4A and FIG. 4B. The tight-fitting rib 130 includes a top face 131, two side faces 133, and an end face 132.

The top face 131 is provided close to an outer end of the circumferential sidewall 110 along an insertion direction (i.e., depth direction D). The two side faces 133 face each other in opposite directions, respectively connecting to the top face 131 and the end face 132, and extend generally along the height direction H of the tight-fitting rib 130 from the circumferential sidewall 110. The end face 132 is at a position of the tight-fitting rib 130 away from the circumferential sidewall 110 and is connected between the top face 131 and the two side faces 133. Therefore, the tight-fitting rib 130 is a substantially rectangular column enclosed by the top face 131, the side faces 133, and the end face 132.

In some embodiments, thickness of each tight-fitting rib 130 may be between 0.9 mm and 1.5 mm, preferably 1 mm. If the thickness is too small, the tight-fitting rib 130 may not be strong enough to provide sufficient support strength for the insertion part 200 after undergoing elastic deformation or lateral deflection. If the thickness is too large, the tight-fitting rib 130 may be too strong to undergo the elastic deformation or the lateral deflection, thus failing to achieve the tight-fitting function.

In some embodiments, a plurality of tight-fitting ribs 130 are provided on the circumferential sidewall 110 of the mounting part 100 at intervals in a circumferential direction, with some of the tight-fitting ribs 130 oppositely oriented, for example, the tight-fitting ribs 130 located on the left sidewall 111 and right sidewall 112 of the circumferential sidewall 110 in FIG. 5, and the tight-fitting ribs 130 located on the upper sidewall 113 and lower sidewall 114 of the circumferential sidewall 110 in FIG. 5. A sum of the heights of the oppositely oriented tight-fitting ribs 130 on the circumferential sidewall 110 of the mounting part 100 may be between 0.5 mm and 0.9 mm. Here, the circumferential direction refers to the thickness direction W of each tight-fitting rib 130. In some embodiments, the end face of the circumferential sidewall 110 of the mounting part 100 has a substantially rectangular shape (for example, the circumferential sidewall 110 as shown in FIG. 3). The circumferential sidewall 110 has a first sidewall and a second sidewall are opposite to each other (for example, the left sidewall 111 and the right sidewall 112, or the upper sidewall 113 and the lower sidewall 114). The heights of the tight-fitting ribs 130 located on each sidewall are identical. The height of the tight-fitting ribs 130 located on the first sidewall is H1, and the height of the tight-fitting ribs 130 located on the second sidewall is H2 (for example, the height of the tight-fitting ribs on the left sidewall is H1, and the height of the tight-fitting ribs on the right sidewall is H2; or the height of the tight-fitting ribs on the upper sidewall is H1, and the height of the tight-fitting ribs on the lower sidewall is H2). A sum of H1 and H2 is between 0.5 mm and 0.9 mm. In some other embodiments not shown, the end face of the circumferential sidewall 110 of the mounting part 100 has a substantially circular shape. The oppositely oriented tight-fitting ribs 130 (i.e., the tight-fitting ribs 130 located on the same diameter) may be provided on the substantially circular circumferential sidewall 110, and a sum of the heights of the oppositely oriented tight-fitting ribs 130 is between 0.5 mm and 0.9 mm. Such configuration can facilitate the deformation of the tight-fitting ribs 130. Thus, when inserting the insertion part 200 into the mounting part 100, a relatively small force is required, and the operation is more convenient. At the same time, after the insertion part 200 is removed from the mounting part 100, the tight-fitting ribs 130 can easily return to their original shape. If the height is too small, the tight-fitting ribs 130 may not deform elastically or deflect. If the height is too large, the tight-fitting ribs 130 may deform or deflect excessively, failing to provide the necessary supporting strength.

In some embodiments, the top face 131 may have a chamfer or a curved contour, for example, at a position where the top face 131 is connected to the end face 132. When the insertion part 200 is inserted into the mounting part 100, the chamfer or curved contour on the top face 131 guides the insertion part 200 to be fully inserted into the mounting groove 120 of the mounting part 100, while causing the tight-fitting rib 130 to undergo lateral deflection deformation. As a result, the tight-fitting rib 130 can abut against the insertion part 200 more stably, to prevent the insertion part 200 from shaking.

In some embodiments, each tight-fitting rib 130 has a conical shape, with its thickness gradually decreasing from the circumferential sidewall 110 towards the center of the mounting part 100, that is, each tight-fitting rib 130 has a gradually decreasing thickness along the height direction H. More specifically, each tight-fitting rib 130 has a larger thickness W2 close to the corresponding circumferential sidewall 110 and a smaller thickness W1 away from the circumferential sidewall 110, as shown in FIG. 4A and FIG. 4B. Therefore, the tight-fitting rib 130 can easily approach to the insertion part 200 and can be easily deformed to securely hold the insertion part, thereby preventing the insertion part 200 from shaking.

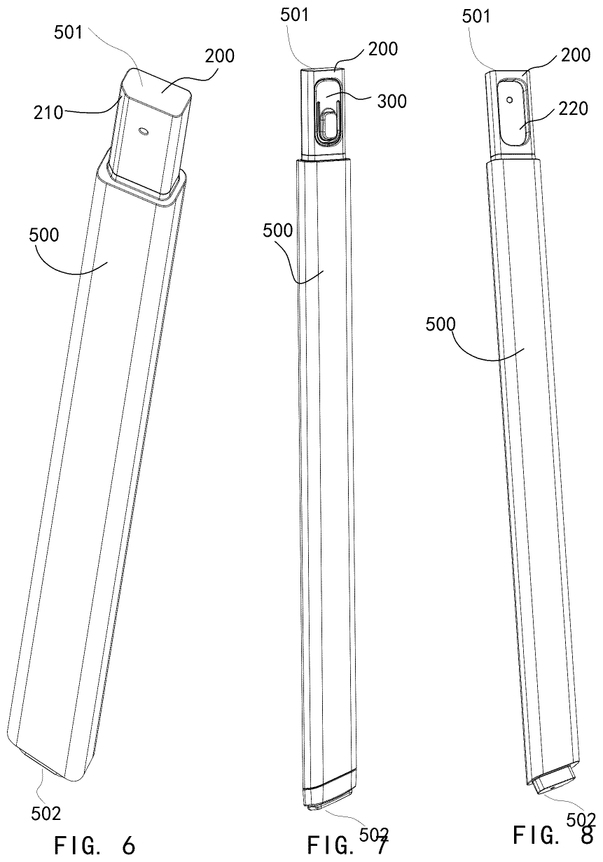

In some embodiments, referring to FIG. 3 and FIG. 5, the mounting part 100 is substantially rectangular and has at least one anti-mismatching rib 150 at one corner thereof. The anti-mismatching rib 150 has a shape substantially similar to that of the tight-fitting rib 130 and may be longer than the tight-fitting rib 130, that is, extending further towards the center of the mounting part 100. The anti-mismatching rib 150 is used to assist the positioning of the support leg 500. In conjunction with FIG. 6, the insertion part 200 has a shape substantially corresponding to that of the mounting part 100 and is notched at one corner to form a positioning part 210. Therefore, when the positioning part 210 is aligned with the anti-mismatching rib 150, the insertion part 200 may be inserted into the mounting part 100. When an installation angle of the support leg 500 is incorrect and the positioning part 210 is not aligned with the anti-mismatching rib 150, the insertion part 200 may not be inserted into the mounting part 100. Therefore, the chair connection structure of the present disclosure can prevent users from inserting the support leg 500 in a wrong direction.

In some embodiments, at least one abutment part 140 is provided on the bottom wall 170 of the mounting part 100, and abuts against an end of the insertion part 200 (see FIG. 3 and FIG. 12). The abutment part 140 may be block-shaped and provided close to edges of the bottom wall 170 of the mounting part 100. Due to the abutment part 140, the insertion part 200 can be held in the mounting part 100 more stably, to prevent the insertion part 200 (and the support leg 500) from shaking. Furthermore, the end surfaces of the respective abutment parts 140 (that is, the surfaces abutting against the support leg 500) are on the same plane and all abut against the upper surface 501 of the support leg 500. The upper surface 501 of the support leg 500 is parallel to the lower surface 502 thereof (see FIGS. 6-8).

In some embodiments, the circumferential sidewall 110 of the mounting part 100 is provided with a mounting hole 160, which is, for example, a through-hole penetrating the circumferential sidewall 110. Hereinafter, function of the mounting hole 160 will be described in conjunction with the connector 300.

Furthermore, the chair according to the present disclosure also includes a connector 300, which is connected between the insertion part 200 and the mounting part 100 to further enhance the connection stability between the support leg 500 and the chair body 400. The support leg 500, the insertion part 200, and the connector 300 are described below with reference to FIG. 6 to FIG. 8. The insertion part 200 may be integrally formed with the support leg 500 and located at the upper end of the support leg 500. Therefore, the upper surface 501 of the support leg 500 may be an upper surface of the insertion part 200. A cross-sectional area of the insertion part 200 may be smaller than that of the support leg 500, so that when the insertion part 200 is inserted into the mounting part 100, the support leg 500 is substantially flush with the outer surface 310 of the mounting part 100 (see FIG. 1), thereby forming a neat appearance.

The connector 300 is partially embedded in the insertion part 200. Specifically, the side surface of the insertion part 200 is provided with a receiving part 220, which is recessed downward from the side surface of the insertion part 200 and has a substantially rectangular end face. The connector 300 may be mounted in the receiving part 220 of the insertion part 200.

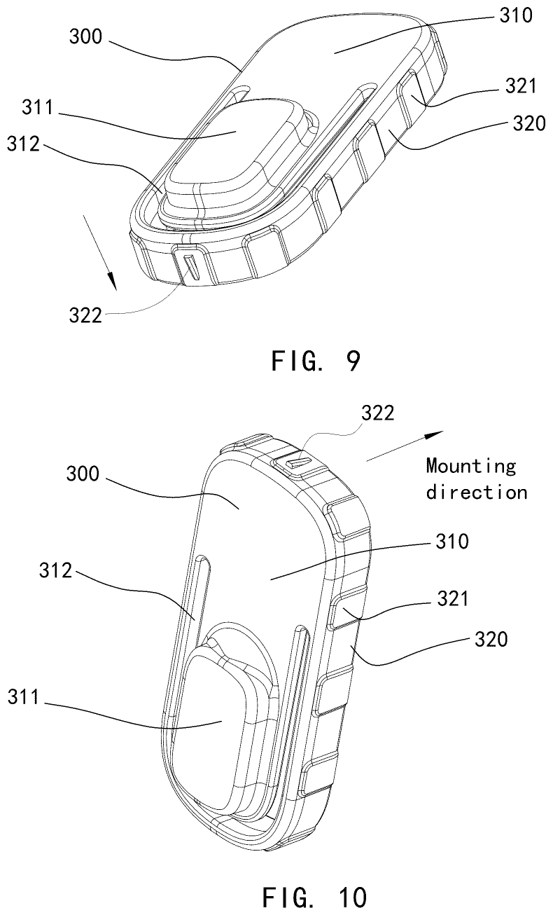

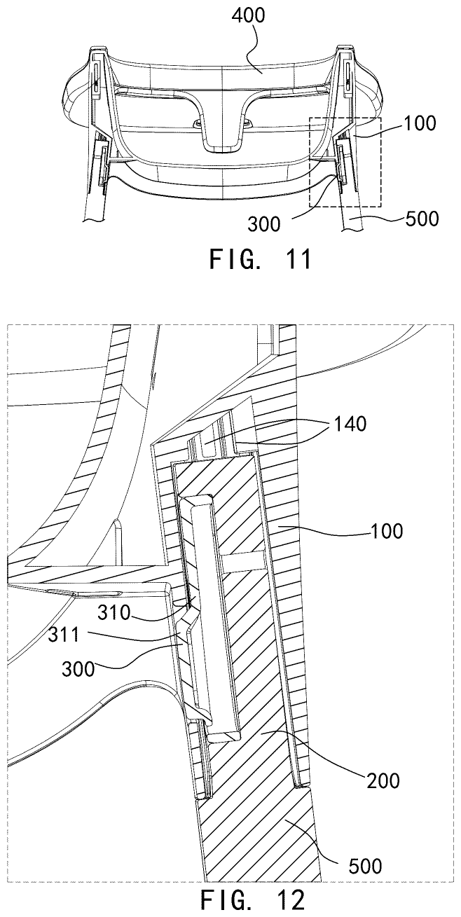

The connector 300 is described in more detail with reference to FIG. 9 and FIG. 10. The connector 300 has a connector body and a locking part 310 extending from the connector body. The locking part 310 is in a form of an elastic arm structure. A fixed end of the locking part 310 is connected to the connector body, and a free end of the locking part 310 is provided with a locking protrusion 311. The locking protrusion 311 has a substantially rectangular shape. After the connector 300 is mounted in the receiving part 220, the locking protrusion 311 faces an outside of the insertion part 200. Referring to FIG. 3, the circumferential sidewall 110 of the mounting part 100 is provided with a corresponding locking hole 160. During a process of inserting the insertion part 200 into the mounting part 100, the locking part 310 in the form of an elastic arm undergoes deformation, and the locking protrusion 311 is finally engaged with the locking hole 160, so that the insertion part 200 is locked into the mounting part 100, to further enhance the connection stability between the support legs 500 and the chair body 400.

Referring to FIG. 9 and FIG. 10, the connector body is in a substantially rectangular cylinder shape and has a peripheral surface 320. The peripheral surface 320 is also provided with a plurality of engaging parts 321 distributed at intervals in the circumferential direction. When the connector 300 is mounted in the receiving part 220, the connector 300 forms an interference fit with the inner wall of the receiving part 220 via the engaging parts 321, thereby securely installing the connector 300 in the receiving part 220. In some embodiments, referring to FIG. 9 and FIG. 10, the connector 300 further includes an engaging protrusion 322 provided on one or more engaging parts 321. The engaging protrusion 322 protrudes outward from the engaging part 321 and has a rib-like structure. In this way, the installation stability of the connector 300 and the receiving part 220 is further enhanced. Preferably, the height of the engaging protrusion 322 is gradually varied. Specifically, the height of the engaging protrusion 322 is gradually decreased towards the mounting side. This can facilitate the initially mounting the connector 300 to the receiving part 220. Preferably, the engaging protrusions 322 are symmetrically distributed along the peripheral surface 320, in other words, the engaging protrusions 322 are provided on an even number of engaging parts 321 that are symmetrically distributed along the peripheral surface 320, so that the engaging protrusions 322 act more evenly when the connector 300 is mounted in the receiving part 220.

Although preferred embodiments have been shown and described here, it should be understood that these embodiments are given only as examples. The person skilled in the art would think of many variations, changes, and substitutions without departing from the spirit of the present disclosure. Therefore, the accompanying claims are intended to cover all such variations that fall within the spirit and scope of the present disclosure.

What is claimed is:

1. A chair, comprising a chair body and support legs connectable to the chair body, one of a lower part of the chair body and an upper part of the support legs being provided with a mounting part, and the other of the lower part of the chair body and the upper part of the support legs being provided with an insertion part, the insertion part being insertable into the mounting part along an insertion direction to mount the support legs to the chair body, wherein
a tight-fitting rib protruding is inwardly provided on an inner surface of a circumferential sidewall of the mounting part, and the tight-fitting rib is elastically deformed to abut between the insertion part and the circumferential sidewall of the mounting part in the situation the insertion part is inserted into the mounting part, securing the support legs to the chair body.

2. The chair according to claim 1, wherein the circumferential sidewall has a symmetry plane, and the tight-fitting rib is provided in plurality, the plurality of tight-fitting ribs are symmetrically distributed with respect to the symmetry plane.

3. The chair according to claim 1, wherein the tight-fitting rib extends over an entire depth of the circumferential sidewall.

4. The chair according to claim 1, wherein the tight-fitting rib has a thickness of 0.9-1.5 mm along the circumferential sidewall.

5. The chair according to claim 1, wherein the circumferential sidewall of the mounting part is provided with a plurality of tight-fitting ribs, and a sum of heights of the tight-fitting ribs disposed opposite to each other of the plurality of tight-fitting ribs is 0.5-0.9 mm.

6. The chair according to claim 1, wherein the insertion part is provided with a positioning part, and the circumferential sidewall of the mounting part is provided with an anti-mismatching rib corresponding to the positioning part.

7. The chair according to claim 1, wherein the mounting part further comprises a bottom wall, the bottom wall is provided with one or more abutment parts, a top face of the abutment part forms an abutment plane, the abutment plane is parallel to an upper surface of the support leg, and when the insertion part is inserted into the mounting part, the abutment plane abuts against the upper surface of the support leg.

8. The chair according to claim 1, further comprising a connector, a receiving part is formed on a side surface of the insertion part, the connector is mounted in the receiving part, the connector further comprises a connector body and a locking part extending from the connector body, the circumferential sidewall of the mounting part is further provided with a locking hole, and when the insertion part is inserted into the mounting part, the locking part is locked in the locking hole.

9. The chair according to claim 8, wherein the connector body has a peripheral surface, the connector body comprises a plurality of engaging parts protruding from the peripheral surface and distributed at intervals along the peripheral surface.

10. The chair according to claim 9, wherein the connector body further comprises an engaging protrusion provided on one or more of the engaging parts, and the engaging protrusion protrudes from the engaging part.
